(19) United States
(12) Patent Application Publication
(10) Pub. No.: US 2006/0266977 A1
(43) Pub. Date: Nov. 30, 2006

(54) Use of dispersants to improve the retention of fluidity of concrete

(75) Inventors: Isabelle Dubois-Brugger, Avon (FR); Mathieu Gratas, Rouvres St. Jean (FR); Olivier Malbault, Boutigny Sur Essonne (FR); Martin Mosquet, Dadonville (FR)

Correspondence Address: BARNES & THORNBURG LLP, P.O. BOX 2786, CHICAGO, IL, 60690-2786, US

(73) Assignee: CHRYSO, Issy Les Moulineaux (FR)

(21) Appl. No.: 10/552,244

(22) PCT Filed: Apr. 9, 2004
(86) PCT No.: PCT/FR04/00896

§ 371 Date: Jun. 6, 2006

(30) Foreign Application Priority Data
Apr. 11, 2003 (FR) 0304566

(51) Int. Cl. C09K 13/00

(52) U.S. Cl. 252/79.1

(57) ABSTRACT

The invention relates to the use of polycarboxylates of polyoxyalkylene for the production of compositions of concrete wit a slump value T0 of between 12 and 20 cm inclusive, for improving the retention of fluidity with time. The invention further relates to fresh concrete compositions with such a slump value containing said dispersant.

The present invention relates to dispersants for concretes, and more particularly the use of a dispersant of the polycarboxylic type in order to prolong the fluidity retention of concrete compositions. It also relates to concrete compositions of this type.

Dispersants are used in the preparation of hydraulic setting materials in order to reduce the water content whilst preserving fluidity retention and/or a small slump loss for the length of time required to shape them.

These dispersants are sometimes referred to as water reducers, liquifiers, plasticisers or, when they are used in larger quantities, superplasticisers.

These additives allow concrete compositions to be obtained at the desired consistency with reduced water contents and, consequently, an improvement in the mechanical strength of the compositions of hardened concrete.

It is thus known to use gluconate or lignosulphonate compounds as dispersants. However, these dispersants allow concrete compositions to be produced which retain their fluidity for a limited length of time. When the concrete is prepared in a plant before being brought to the site in a form which is ready to use, it is desirable to be able to maintain the fluidity retention for a period of time of up to 60 minutes, preferably 90 minutes or even longer.

However, a larger quantity of dispersant carries the risk of bringing about uncontrolled delays in terms of the concrete setting.

Furthermore, these dispersants have the disadvantage of being effective only at very limited temperatures. It has thus been found that they lead to unsatisfactory results at high temperatures, for example, of 30° C.

Finally, it has been found to be difficult to obtain a satisfactory level of workability when these dispersants are used in concrete compositions comprising cements which are referred to as having additives. These cements are used in particular for concretes of class B25 to B40.

Over recent years, dispersants based on polycarboxylates have been developed.

Application FR 2 776 285 thus describes dispersants which are obtained by means of partial esterification of a polycarboxylic acid with a polyether for cement compositions.

The object of the present invention is therefore to provide a dispersant which allows the fluidity retention to be prolonged for concrete compositions having a slump value of between 12 and 20 cm.

Another object is to provide a dispersant of this type which is polyvalent and which is in particular compatible with concrete compositions comprising various types of cement.

Another object is to provide a dispersant of this type which is effective at a temperature of between 2 and 30° C.

The present invention is based on the finding that the use of specific polycarboxylates in concrete compositions having a slump value of between 12 and 20 cm allows the fluidity retention thereof to be significantly prolonged without for all that having the disadvantages of the dispersants of the prior art.

The slump value allows the plasticity and therefore the workability of a concrete composition to be evaluated. It is determined by measuring the settlement of a sample of wet concrete which is poured into a specific conical receptacle (Abrahams cone), then removed from the mould. The slump value decreases with the hydration of the concrete and over time. In this manner, slump values in the fresh state (T0) are distinguished from those at 30, 60 or 90 minutes.

In the context of the present text, the term “fluidity retention” is thus intended to refer to the fact that a concrete composition has a slump value after 90 minutes (T90) of at least 60%, preferably 70% and, more preferably, 80% of the slump value in the fresh state (T0).

More precisely, the invention relates to the use of polyoxyalkylene polycarboxylates comprising at least 50%, preferably at least 75% by number of a random linear chain formation of structural units (1) and (2) illustrated by the following formulae: 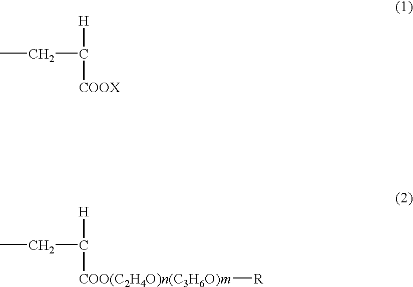
in which X represents a hydrogen atom, an alkali metal, an alkaline-earth metal or ammonium, the structural units (1) being able to be identical or different; n is an integer of from 0 to 24, m is a whole number in the order of from 0 to 24, with men, the propylene oxide groups being able to be distributed or not in a random manner amongst the ethylene oxide groups, R represents an alkyl or alkenyl group having from 1 to 24, preferably 1 to 18 carbon atoms, the structural units (2) being able to be identical or different; the ratio of the number of structural units (2) to the total number of structural units (1) and (2) being between 20 and 80%, preferably between 40 and 60%, alone or in admixture, in order to improve the fluidity retention of concrete compositions having a slump value of between 12 and 20 cm.

Polyoxyalkylene polycarboxylate can further comprise a maximum of 50%, preferably a maximum of 25% by number of structural units other than the structural units (1) and (2). These are preferably structural units derived from methacrylic acid (1)′ and (2)′ 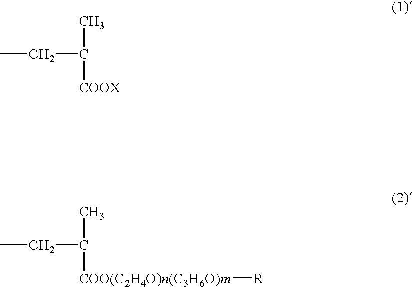
in which n, m, X and R have the meanings given above.

Advantageously, polyoxyalkylene polycarboxylate comprises from 5 to 45%, preferably from 5 to 20% by number of structural units (1)′ and (2)′.

By way of example of other structural units which may be present, it is possible to mention units which are formed from unsaturated monomers which comprise sulphone-containing groups or alkyl ester groups. Such units should not, however, include an excessive presence of monomers known in the art for producing a sufficiently clear retardation of the setting times, such as, for example, phosphone-containing or phosphate-containing monomers.

According to a preferred variant of the invention, the dispersant of the polycarboxylic type comprises at least 80%, preferably at least 90% by number of structural units (1) and (2), more preferably 95%, and most particularly 100% by number of structural units (1) and (2), without taking into account the units which serve as chain ends and which are linked to the methods for initiating polymerisation and controlling chain length.

Still more preferably, the dispersant has a chemical structure which has one or more of the following characteristics:
m is equal to zero;
n is an integer of from 3 to 24;
n is an integer of from 5 to 24;
n is equal to zero;
R represents an alkyl or alkenyl group having from 1 to 18 carbon atoms, such as a methyl, ethyl, propyl, butyl, oleyl, stearyl or palmitic group.

The dispersant preferably has a ratio of the number of structural units (2), which correspond to esters of the structural units. (1), to the total number of the structural units (1) and (2) of between 20 and 80%, preferably between 40 and 60%. The same preferences apply to the structural units (1)′ and (2)′ which are optionally present up to a maximum of 25% by number.

According to a specific embodiment of the invention, the dispersant comprises from 0.1 to 2%, in particular from 0.5 to 1.5% of structural units (2) having at least one of the following characteristics:
n is equal to 0;
m is not equal to 0;
R represents an alkyl or alkenyl group having from 6 to 24 carbon atoms.

The mean molar mass by weight MW of the dispersant used according to the invention, measured by means of steric exclusion chromatography, with polyethylene glycol calibration is generally from approximately 7000 to 50000 g/mole.

The dispersant is generally used in liquid form.

In this manner, according to another aspect of the invention, the dispersant used is in the form of an aqueous solution of from 20 to 40% of dry extract.

Advantageously, the quantity of dispersant added to the concrete composition is between 0.2 and 0.8% of liquid, in particular between 0.25 and 0.75% of liquid, relative to the quantity of cement.

The term “of liquid” refers to the quantity by weight of dispersant formulated. In this manner, for a formulation having 30% of dry extract, the dispersant is generally added at a ratio of from 0.05 to 0.3, preferably from 0.06 to 0.24 and in particular from 0.075 to 0.225% by weight relative to the quantity of cement.

Various other additives for concrete compositions known to the person skilled in the art can inter alia be added to these compositions of fresh concrete. By way of example, it is possible to mention setting acceleration agents, air entraining agents, antifoaming agents or setting retarding agents.

The concrete compositions may comprise, as a hydraulic binder, various types of cement, such as, for example, CEM I, CEM II cements. Of these, the CEM I cements do not comprise any additives. However, it is possible to add additives such as slags, flue dust, calcic fillers and siliceous fillers to these cements. The concrete compositions can be concretes having various classes of strength, such as B25, B30, B35 or B40 types.

The invention also relates to a fresh concrete composition having a slump value T0 of between 12 and 20 comprising the dispersant as described above.

Various methods for producing the dispersant used according to the invention can be envisaged.

According to a first method of production, the dispersant selected can be obtained by means of co-polymerisation of a monomer a illustrated by the formula A below with at least one monomer b selected from the compounds illustrated by the formula B below: 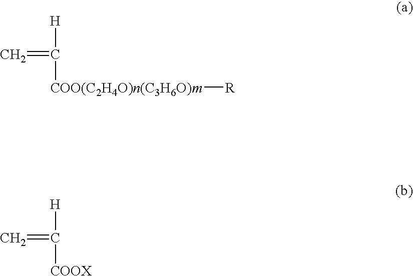
in which X, n, m and R have the meanings given above.

According to a second method of production, the dispersant can be obtained by means of partial esterification, catalysed using a base, by reacting a polyacrylic acid with a polyether containing a hydroxyl group which can react with a carboxylic function, optionally salified, of the polyacrylic acid having the general formula:
HO—(C₂H₄O)n(C₃H₆O)m-R
in which n, m and R are as defined above.

According to the second method for producing the dispersant, the polyacrylic acid is obtained by means of polymerisation of a mixture of monomers comprising at least 50, preferably at least 75 molar % of acrylic acid and a maximum of 50, preferably at least 25 molar % of a different co-monomer, such as methacrylic acid. However, there is preferably 80, 90, 95 and most particularly 100 molar % of acrylic acid without taking into account the endgroups.

The base which is generally used to catalyse the partial esterification reaction is an alkali metal hydroxide, preferably of sodium or lithium. However, it is also possible to use another base, such as a tertiary amine.

For further details relating to the preparation of the dispersants, reference can be made to patent application FR 2 776 285 which is incorporated herein by reference.

Of these methods described, the method of partial esterification catalysed by a base is preferred. It would appear that, in this method of production, the content of residual reagent is very limited.

The dispersant as defined above can be used alone or in admixture. It can also be used in combination with other conventional dispersants, such as, for example, those derived from the condensation of formaldehyde and sulphonated naphthalene or those derived from the condensation of formaldehyde and sulphonated melamine since they have no significant effect on the fluidity retention.

The non-limiting examples below illustrate the present invention.

### EXAMPLES

Preparation of the Dispersants

First Method of Preparation

According to the first method of preparation, the dispersant is prepared by means of co-polymerisation:
of acrylic acid, marketed by the company Sigma Aldrich;
with a methacrylate of methyl polyethylene glycol, having a variable mean molar mass by weight, marketed by the company Sigma Aldrich.
   Second Method of Preparation

According to the second method of preparation by means of partial esterification, catalysed using a base, the dispersant selected is obtained by reacting:
a polyacrylic acid having a mean molar mass by weight measured at 4000 g/mole diluted to 50% in water, acidity index 333 mg KOH/g (Sokalan CP 10 S from BASF);
or a polymethacrylic acid having a mean molar mass by weight measured at 4000 g/mole diluted to 30% in water and obtained by means of polymerisation of the methacrylic acid in the presence of thioglycolic acids catalysed by oxygenated water;
with a methoxypolyethylene glycol having a molar mass of 350 g/mole (polyglycol M350 from Clariant) or a molar mass of 1100 g/mole (polyglycol M1100 from Clariant).
   Dispersants

Dispersants A-F of the polycarboxylate ethylene polyoxide type and, by way of comparison, dispersants G and H, were prepared according to the second method of preparation described above. Their mass composition is summarised in Table 1 below.

TABLE 1
Mass Composition of the Dispersants

| | | | | Level of |
|---|---|---|---|---|
| Dispersants | % PAA | % MPEG | % LiOH | ester |
| A | 61.10 | 38.18 | 0.76 | 30 |
| B | 57.41 | 41.87 | 0.71 | 35 |
| C | 54.05 | 45.28 | 0.67 | 40 |
| D | 51.27 | 48.09 | 0.64 | 45 |
| E | 48.68 | 50.72 | 0.60 | 50 |
| F | 46.33 | 50.10 | 0.57 | 55 |
| G | 68.04 | 31.512 | 0.448⁺ | 40 |
| H | 50.37 | 41.3 | 0.60 | 40 |

*PAA: Sokalan CP 10 S, except for G: methacrylic acid; ⁺% NaOH; MPEG = polyglycol M350, except for H polyglycol 1100; method of preparation according to FR 2 776 285.

The polymer which is obtained in this manner is anhydrous and can be manipulated at ambient temperature.

Formulation

The dispersants which are obtained in this manner are then formulated. 0.5% by weight of Noramox O2 (CECA) is added to 30% by weight of dispersant as a surfactant. 0.5% by weight of tributylphosphate is also added as an antifoaming agent. The pre-mixture is neutralised using washing soda up to a pH value of 7 before being made up to 100% with water.

Example of Use

The formulations of the dispersants obtained above were incorporated into a reference concrete composition B25 having the following composition per 1 m³:

| | |
|---|---|
| Cement CEM I 52.5 N | 230 Kg |
| Cordemais flue dust | 90 Kg |
| Palvadeau 12.5/20 | 474.5 Kg |
| Palvadeau 8/12.5 | 316 Kg |
| Palvadeau 4/8 | 252.2 Kg |
| Palvadeau 0/4 (% hum. = 3.9%) | 643 Kg |
| Water | 175 Kg |

In order to evaluate the strength of the dispersants, two cements of a different chemical type were used, that is to say, CEM 152.5 N Saint Pierre La Cour and CEM 152.5 Le Havre. The concretes were produced in accordance with the Standard NF EN 206-1 and T0 corresponds to the slump just after the end of mixing for 55 seconds after the addition of the water.

By way of comparison, the same admixtures were produced with commercially available plastifiers, Chrysoplast CER, based on sodium gluconate (designated CER) and Chrysoplast 209, based on calcium lignosulphonate (designated 209), available from Chryso.

Tables 2 and 3 below indicate, for each of the formulations of dispersant used, the quantity, the E/L ratio and the slump values immediately after preparation (fresh concrete) (T0), at 30 minutes (T30), at 60 minutes (T60) and at 90 minutes (T90).

After 24 hours, the strength Rc of the pieces obtained was determined at 10° C. (standard NF P18-421).

All of the results are set out in Table 2 for cement CEM I 52.5 N Saint Pierre La Cour and in Table 3 for cement CEM I 52.5 N Le Havre.

TABLE 2
Concrete based on cement CEM I 52.5 N Saint Pierre La
Cour

| | Quan- | | | | | | Rc 24 h at |
|---|---|---|---|---|---|---|---|
| For- | tity | | Slump | Slump | Slump | Slump | 10° C. |
| mula | (%) | E/L | T0 | T30 | T60 | T90 | (Mpa) |
| 209 | 0.3 | 0.566 | 14.5 | 9.5 | 8 | 5.5 | 5.8 |
| CER | 0.3 | 0.566 | 16.5 | 11 | 9 | 8.5 | 4.8 |
| A | 0.3 | 0.558 | 15.5 | 14.5 | 13 | 10 | * |
| B | 0.3 | 0.582 | 16 | 16 | 16 | 15.5 | 4 |
| C | 0.3 | 0.566 | 15.5 | 14.5 | 15.5 | 14.5 | 4.22 |
| D | 0.3 | 0.566 | 15.5 | 14 | 13.5 | 12.5 | 4.32 |
| E | 0.3 | 0.566 | 15 | 15 | 15 | 15 | 7.4 |
| F | 0.3 | 0.583 | 16 | 14 | 13 | 10 | * |
| G | 0.3 | 0.514 | 15.5 | 13 | 10.5 | 9 | 3.9 |
| H | 0.3 | 0.561 | 16 | 11 | 8 | 8 | 4.01 |

TABLE 3
Concrete based on cement CEM I 52.5 N Le Havre

| | Quan- | | | | | | Rc 24 h at |
|---|---|---|---|---|---|---|---|
| For- | tity | | Slump | Slump | Slump | Slump | 10° C. |
| mula | (%) | E/L | T0 | T30 | T60 | T90 | (Mpa) |
| 209 | 0.3 | 0.566 | 15.5 | 11 | 7.5 | 5.5 | 4.0 |
| CER | 0.3 | 0.547 | 16.5 | 12.5 | 9.5 | 7 | 2.3 |
| A | 0.3 | | | | | | |
| B | 0.3 | 0.556 | 17.5 | 16.5 | 16 | 11 | 3.72 |
| C | 0.3 | 0.531 | 15.5 | 14 | 13 | 11 | 3.75 |
| D | 0.3 | 0.566 | 16 | 15.5 | 12.5 | 12 | 3.13 |
| E | 0.3 | 0.547 | 16 | 16.5 | 14 | 12 | 5.0 |
| F | 0.3 | | | | | | |
| G | 0.3 | 0.521 | 15.5 | 13 | 10 | 8.5 | 4.2 |
| H | 0.3 | 0.529 | 15.5 | 10 | <6 | <6 | 3.83 |

The results clearly indicate that, compared with conventional dispersants and under comparable operating conditions, dispersants A to F allow the fluidity retention of the concrete to be significantly prolonged. It is thus found that, even after 90 minutes, the slump values measured are still at least 60% of the slump value measured in the fresh state. Generally, this ratio is in the order of 80%.

Furthermore, it is found that the dispersants used according to the invention have no effect on the other properties of the concrete. In particular, they allow strength values Rc at 24 h to be maintained which are comparable to or even greater than those obtained with conventional dispersants.

It is also found that the results are completely satisfactory for the various types of cement tested. The use of these dispersants is thus not limited to one particular type of cement; instead they are strong and can be used for concrete compositions which comprise cements of different chemical types.

Therefore, it appears that the presence of units of acrylic acid has a beneficial effect in terms of retaining the fluidity of the concretes. Dispersant G, prepared with methacrylic acid, has, with an identical quantity and initial slump value, lower slump values T60 and T90 than dispersants A to F.

Finally, the presence of short polyalkoxylene chains in the dispersants also appears to contribute to the retention of fluidity. Dispersant H having short polyalkoxylene chains thus provides a lower level of fluidity retention compared, for example, with dispersant C, at the same quantity.

1. Use of polyoxyalkylene polycarboxylates comprising at least 75% by number of a random linear chain formation of structural units (1) and (2) illustrated by the following formulae: 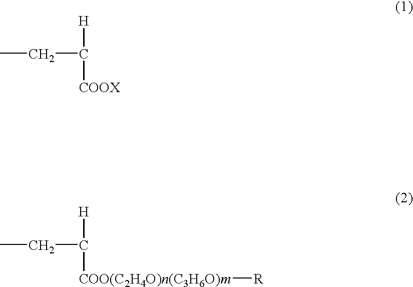
in which X represents a hydrogen atom, an alkali metal, an alkaline-earth metal or ammonium, the structural units (1) being able to be identical or different; n is an integer of from 0 to 24, m is an integer of from 0 to 24, with m<n, the propylene oxide groups being able to be distributed or not in a random manner amongst the ethylene oxide groups, R represents an alkyl or alkenyl group having from 1 to 24 carbon atoms, the structural units (2) being able to be identical or different; the ratio of the number of structural units (2) to the total number of structural units (1) and (2) being between 20 and 80%, alone or in admixture, in order to improve the fluidity retention up to 90 minutes for ready-to-use concrete compositions having a slump value T0 of between 12 and 20 cm.

2. Use according to claim 1, in which the polyoxyalkylene polycarboxylates comprise at least 80% by number of a random linear chain formation of structural units (1) and (2).

3. Use according to claim 1 or 2, in which the ratio of the number of structural units (2) to the total number of structural units (1) and (2) is between 40 and 60%.

4. Use according to any one of claims 1 to 3, in which m is equal to zero.

5. Use according to any one of claims 1 to 4, in which n is an integer of from 5 to 24.

6. Use according to any one of claims 1 to 5, in which R represents an alkyl or alkenyl group having from 1 to 18 carbon atoms.

7. Use according to claim 6, in which R is a methyl, ethyl, propyl, butyl, oleyl, stearyl, palmitoyl moiety.

8. Use according to any one of claims 1 to 7, in which from in 0.1 to 2% of structural units (2), and/or n is equal to zero and/or m is not equal to 0 and/or R represents an alkyl or alkenyl group having from 6 to 24 carbon atoms.

9. Use according to any one of claims 1 to 8, in which the polyoxyalkylene polycarboxylate further has a maximum of 25% by number of structural units (1)′ and (2)′ which are illustrated by the following formulae: 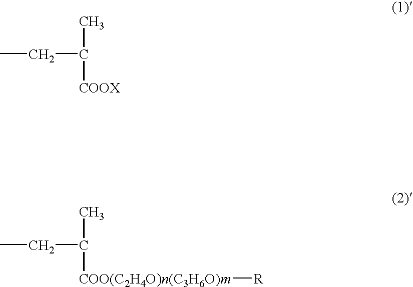
in which n, m, X and R have the meanings given in claim 1.

10. Use according to claim 9, in which the polyoxyalkylene polycarboxylate has from 5 to 20% by number of structural units (1)′ and/or (2)′.

11. Use according to claim 9 or 10, in which the ratio of the number of structural units (2)′ to the total number of structural units (1)′ and (2)′ is between 40 and 60%.

12. Use according to any one of claims 1 to 11, in which the polyoxyalkylene polycarboxylate has a molecular mass of between 7000 and 50000 g/mol.

13. Use according to any one of claims 1 to 12, in which the polyoxyalkylene polycarboxylate is in the form of an aqueous solution of from 20 to 40% of dry extract.

14. Use according to any one of claims 1 to 13, in which the polyoxyalkylene polycarboxylate is added to the concrete composition at a ratio of from 0.2 to 0.8% of liquid relative to the cement.

15. Fresh concrete composition having a slump value T0 of from 12 to 20 and comprising the dispersant specified in claims 1 to 14.
